(19) United States
(12) Patent Application Publication
(10) Pub. No.: US 2012/0190799 A1
(43) Pub. Date: Jul. 26, 2012

(54) Polyamide Curative Composition

(75) Inventors: Natesh Anbazhagan, North Wales, PA (US); Sudhir Ananthachar, Hillsborough, NJ (US); Alexander Y. Polykarpov, Brunswick, OH (US); Shailesh C. Shah, Dresher, PA (US); Vasudevan Balasubramaniam, Goshen, NY (US)

(73) Assignee: Cognis IP Management GmbH, Dusseldorf (DE)

(21) Appl. No.: 13/238,543

(22) Filed: Sep. 21, 2011

Related U.S. Application Data
(60) Provisional application No. 61/385,308, filed on Sep. 22, 2010.

(51) Int. Cl. C08L 63/02; C08J 3/00; C08G 69/26

(52) U.S. Cl. 525/391; 528/332

(57) ABSTRACT

The present invention relates to a polyamide curative composition comprising a reaction product (P) of (1) at least three compounds of formula H₂NCH₂CH₂(NHCH₂CH₂)ₓNH₂ with x=1 or higher with (2) a dimer fatty acid and (3) a carboxylic monoacid, with the proviso that the composition is free of tetrahydro-pyrimidine-containing compounds and free of piperazine-containing compounds and the proviso that the dimer fatty acid (2) building block of (P) contains less than 50% of non-cyclic dimer fatty acid isomers.

### CROSS-REFERENCE TO RELATED APPLICATIONS

This application claims priority to U.S. provisional patent application Ser. No. 61/385,308, filed Sep. 22, 2010, which is incorporated herein by reference in its entirety.

### TECHNICAL FIELD

The invention relates to a polyamide curative composition comprising a reaction product (P) of (1) at least three compounds of formula H₂NCH₂CH₂(NHCH₂CH₂)ₓNH₂ with x=1 or higher with (2) a dimer fatty acid and (3) a carboxylic monoacid, with the proviso that the composition is free of tetrahydropyrimidine-containing compounds and free of piperazine-containing compounds and the proviso that the dimer fatty acid (2) building block of (P) contains less than 50% of non-cyclic dimer fatty acid isomers.

### BACKGROUND

As pointed out in the article “Novel TETA-free polyamides for 2K epoxy systems” by Marcelo Rufo, Michael Cook, Gamini Vedage, Hiroya Morimoto and Dilip Shah (Air Products and Chemicals, Inc. 2008), available from www.airproducts.com as pdf-file (the contents of the article were presented on Jun. 2, 2008 within the American Coating show) the first commercial polyamides from dimer fatty acids with primary amines took place in the late 40's. Since then, this class of polyamides has been widely used in 2K-epoxy coatings and adhesives. Formulations based on these polyamides provide excellent adhesion, flexibility and corrosion resistance, and thus have found wide market acceptance in the marine and protective coatings market to provide protection to bridges, offshore platforms and merchant shipping both new builds and repair. Very often this class of polyamides contains triethylenetetramine (TETA) as building block.

In this article the reaction of ethylene amines and dimer fatty acid is shown as follows:

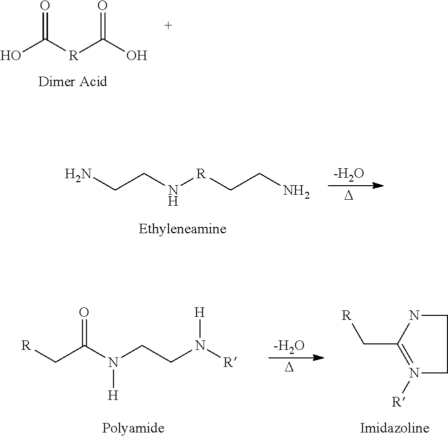

From this scheme one can see that polyamide curing agents for 2K epoxy systems can be obtained by reacting dimer fatty acid with ethylene amines in a condensation reaction (water is set free) to form an amine link and the reaction can then continue under higher process temperatures to form the (cyclic) imidazoline.

EP 1865013 A1 and U.S. Pat. No. 7,655,736 B2 disclose polyamide curing agent compositions comprising the re action products of (1) multifunctional amines of structure R¹R⁴N—X—NR²R³ where R¹ is CH₂CH₂CH₂NH₂; R², R³ and R⁴ independently are H or CH₂CH₂CH₂NH₂, and X is CH₂CH₂ or CH₂CH₂CH₂ with (2) dimer fatty acids, optionally in combination with monofunctional fatty acids, the reaction product preferably comprising at least 15 weight percent tetrahydropyrimidine-containing components. The curing agent compositions are useful for crosslinking epoxy resins to produce coatings, adhesives, floorings, composites and other articles.

EP 918071A1 discloses compositions of amine terminated polyamide resins useful for curing epoxy resins comprising combinations of fatty mono-acids, dimer acids, polyethyleneamines, and piperazine ring containing polyamines having an NH functionality of 2 or 3 per mole selected from the group consisting of piperazine, or N-aminoalkylpiperazine, where the alkyl chain is a C₂ to C₆ alkyl chain, wherein the ratio of equivalents of fatty mono-acid to dimer acid can range from about 0.001:1 to about 1:1, the ratio of moles of piperazine ring containing polyamine to polyethylene amine can range from about 0.1:1 to about 1:1, and the ratio of moles of polyamine to equivalents of acid can range from about 0.6:1 to about 1.2:1. Coating compositions comprising these polyamide resins are also disclosed.

EP 526190AI proposes an improvement in the curing method of an epoxy resin by the admixture of a polyamide as a crosslinking curing agent, in which the curing agent as well as the epoxy resin composition with admixture of the curing agent has an outstandingly low viscosity as compared with the use of a conventional polyamide to facilitate handling. The improvement can be obtained by using, as the polyamide, a condensation reaction product between (A) an alkylene polyamine having 4 to 20 carbon atoms in a molecule and (B) a dimeric acid mixture containing at least 50 percent by weight of a non-cyclic dimeric acid or an alkyl ester thereof represented by the general formula in which each R is, independently from the other, a hydrogen atom or a C₁₋₄ alkyl group obtained by the dimerization re action of oleic acid or an alkyl ester thereof. When flexibility or bendability is desired of the cured epoxy resin, the condensation reaction is performed, in addition to the reactants (A) and (B), with admixture of a C₅₋₂₁ monobasic carboxylic acid or an alkyl ester thereof.

EP 527548 B1 discloses a resin composition which comprises a thermoplastic, substantially amine-terminated polyamide resin having an amine plus acid number between about 1 and about 50 and having an excess of free amine to acid groups; a reactive diluent containing a polar group; and an epoxy resin having at least two epoxy groups per molecule of epoxy resin; wherein the initial ratio of the epoxy groups to free amine groups is between about 1:1 and about 10:1. The diluent serves to reduce the viscosity of said polyamide resin without adversely affecting the strength of the resin composition. The compositions according to EP 527548 BI are useful as hot-melt adhesives.

### SUMMARY

Provided are polyamide curative compositions comprising a reaction product (P) of (1) at least three compounds of formula (I) H₂NCH₂CH₂(NHCH₂CH₂)ₓNH₂ with x=1 or higher with (2) a dimer fatty acid and (3) a carboxylic monoacid, with the proviso that the composition is free of tetrahydropyrimidine-containing compounds and free of piperazine-containing compounds and the proviso that the dimer fatty acid (2) building block of (P) contains less than 50% of noncyclic dimer fatty acid isomers. Methods of making and using these polyamide curative compositions are also provided.

### DETAILED DESCRIPTION

It was an object of the present invention to provide novel polyamide curative compositions. The term curative compositions refers to the curing of epoxy resins.

The present invention provides a polyamide curative composition comprising a reaction product (P) of (1) at least three compounds of formula (I)

H₂NCH₂CH₂(NHCH₂CH₂)ₓNH₂ (I)

with x=1 or higher with (2) a dimer fatty acid and (3) carboxylic monoacid, with the proviso that the composition is free of tetrahydropyrimidine-containing compounds and free of piperazine-containing compounds and the proviso that the dimer fatty acid (2) building block of (P) contains less than 50% of non-cyclic dimer fatty acid isomers.

In one embodiment, compound (I) is a mixture comprising tetraethylenepentamine (TEPA), pentaethylenehexamine (PEHA) and hexaethyleneheptamine (HEHA).

In one embodiment, compound (I) is E-100, available from Huntsman.

In another embodiment, the polyamide curative composition in addition to compound (I) further comprises one or more polyamines (A), which are primary and/or secondary amines having at least two nitrogen atoms and at least two active amino hydrogen atoms per molecule with the proviso that the polyamines (A) are different from compounds of formula (I). The term “in addition” means that (P) is a reaction product of (1), (A), (2) and (3), with the same proviso, as already disclosed above, namely that the composition is free of tetrahydropyrimidine-containing compounds and free of piperazine-containing compounds and the proviso that the dimer fatty acid (2) building block of (P) contains less than 50% of non-cyclic dimer fatty acid isomers.

In one embodiment, the polyamide curative composition of the invention is free of triethylenetetramine (TETA) as building block for compound (1).

The Dimer Fatty Acid (2)

As known to the man skilled in the art, dimer fatty acids are carboxylic acids which may be obtained by oligomerization of unsaturated carboxylic acids, generally fatty acids, such as oleic acid, linoleic acid, erucic acid and the like. The oligomerization is normally carried out at elevated temperature in the presence of a catalyst, for example of clay. The substances obtained—dimer fatty acids of technical quality—are mixtures in which the dimerization products predominate. However, small amounts of higher oligomers, more particularly so-called trimer fatty acids, are also present. Dimer fatty acids are commercially available products and are marketed in various compositions and qualities. According to the invention, dimer fatty acids preferred as raw materials are those which have a dimer content of at least 70% and more particularly 90% and in which the number of carbon atoms per dimerdiol molecule is mainly in the range from 36 to 44.

The Carboxylic Monoacid (3)

The term “carboxylic monoacid” refers to carboxylic acids which contain one COOH group per molecule. In one embodiment fatty acids are used as compound (3). In a preferred embodiment tall oil fatty acid is used as compound (3). Tall oil fatty acid (TOFA) is known to the man skilled in the art and usually manufactured starting from tall oil. Tall oil, also called liquid rosin or tallol, is a viscous yellow-black odorous liquid obtained as a co-product of the Kraft process of wood pulp manufacture when pulping mainly coniferous trees. Normally crude tall oil contains rosins, unsaponifiable sterols, resin acids (mainly abietic acid and its isomers), fatty acids (mainly palmitic acid, oleic acid and linoleic acid), fatty alcohols, some sterols, and other alkyl hydrocarbon derivates. By fractional distillation tall oil rosin is obtained, with rosin content reduced to 10-35%. By further reduction of the rosin content to 1-10%, tall oil fatty acid (TOFA) can be obtained, which is cheap, consists mostly of oleic acid, and is a source of volatile fatty acids.

The Compounds (A)

Polyamines (A) employed in the context of the present invention are primary and/or secondary amines having at least two nitrogen atoms and at least two active amino hydrogen atoms per molecule with the proviso that the polyamines (A) are different from compounds of formula (I).

In principle aliphatic, aromatic, aliphatic-aromatic, cycloaliphatic, and heterocyclic diamines and polyamines can be utilized as compounds (A). In U.S. Pat. No. 7,655,736 B2 (see column 4, line 61-column 5, line 18) multifunctional amines are listed; from this list those amines may be used, which fulfill the definition of compounds (A) above, together with the proviso they are different from compounds of formula (I).

Examples of suitable polyamines (A) are as follows: Ethylenediamine, diethylenetriamine (DETA), 1,2-propylenediamine, 1,3-propylenediamine, 1,4-butanediamine, 1,5-pentanediamine, 1,3-pentanediamine, 1,6-hexanediamine, 3,3,5-trimethyl-1,6-hexanediamine, 3,5,5-trimethyl-1,6-hexanediamine, 2-methyl-1,5-pentanediamine, bis(3-aminopropyl)amine, N,N′-bis(3-aminopropyl)-1,2-ethanediamine, N-(3-aminopropyl)-1,2-ethanediamine, 1,2-diaminocyclohexane, 1,3-diaminocyclohexane, 1,4-diaminocyclohexane, poly(alkylene oxide) diamines and triamines (such as, for example, JEFFAMINE® D-230, JEFFAMINE® D-400, JEFFAMINE® D-2000, JEFFAMINE® D-4000, JEFFAMINE® T-403, JEFFAMINE® EDR-148, JEFFAMINE® EDR-192, JEFFAMINE® C-346, JEFFAMINE® ED-600, JEFFAMINE® ED-900, JEFFAMINE® ED-2001), meta-xylylenediamine, phenylenediamine, 4,4′-diaminodiphenylmethane, toluenediamine, isophoronediamine, 3,3′-dimethyl-4,4′-diaminodicyclohexylmethane, 4,4′-diaminodicyclohexylmethane, 2,4′-diaminodicyclohexylmethane, 1,3-bis(aminomethyl)cyclohexane, the mixture of poly(cyclohexyl-aromatic)amines linked via a methylene bridge (also known as MBPCAAs) and polyaminoamides. Diethylenetriamine (DETA) is particularly preferred. The compounds (A) can be used individually or in a mixture with one another.

### EXAMPLES

### Example 1

### Preparation of Curing Agent

| Raw Material | Weight % |
|---|---|
| EMPOL ® 935 | 15.57 |
| TOFA | 1.50 |
| EMPOL ® 1020 | 55.14 |
| Monosodium Phosphate | 0.02 |
| DETA | 10.23 |
| Ethyleneamine E-1 00 | 17.24 |
| DER 331 | 0.3 |

EMPOL® 935 is a low viscosity monomer/dimer acid based on C18 fatty acid and available from Cognis. EMPOL® 1020 is a dimer based on C18 fatty acid and available from Cognis. DETA is diethylenetriamine. The amine value of DETA is 1620 with an amine hydrogen equivalent weight of 20.6. Ethyleneamine E-100 (also known as ECA 29) is available from Huntsman Corporation. DER 331 is diglycidylether of bis-phenol A and is available from DOW Chemicals and has an epoxy equivalent weight (EEW) of 190. TOFA is tall oil fatty acid, available from MeadWestvaco.

Reaction: EMPOL® 935 and EMPOL® 1020 were charged into the reaction vessel, then DETA and E-100 and monosodium phosphate were added. The mixture (batch) was stirred well for 30 minutes and then heated to 221° C. under nitrogen. About 6-8% of the batch was set free as water and collected in a receiver during the heat-up. Then a receiver was drained and the drain valve closed. Then the mixture was held under vacuum (50 mmHg) at 221° C. for 2 hours, then the vacuum was broken with nitrogen. The obtained polyamide was analyzed for amine value, IA/AA ratio, viscosity, color and amine hydrogen equivalent weight. The results can be found in Table 1.

TABLE 1
(analytical data):

| | |
|---|---|
| Amine Value | 241 |
| IA/AA ratio *⁾ | 1.0 |
| Viscosity, Poise at 75° C. | 38.6 |
| Amine Hydrogen Equivalent weight | 198 |
| Gardner Color | 8 |
| Clarity | Clear |

*⁾ The “IA/AA ratio” is defined as imidazoline to amidoamine functional group ratio in the polymer (see also the reaction of ethylene amines and dimer fatty acid shown above) measured by FTIR.

### Example 2

### Use of the Curing Agent in an Epoxy Application

104 parts of the polyamide curing agent obtained in example 1 were mixed with 100 parts of epoxy resin DER 331 (having an epoxy equivalent weight (EEW) of 190).

After an induction time of 30 minutes the tack-free-time, through-cure-time and pot life were measured. The data can be found in table 2 (“performance properties”):

TABLE 2
(Performance properties)

| | |
|---|---|
| Tack free time at 25° C. | 4:15 |
| Through cure time at 25° C. | 6:45 |
| Pot life at 25° C. | 4:00 |

Tack free time: The tack free condition is reached and measured using mechanical recorders when the film surface has dried or cured. In this test method the tack free time is achieved when the continuous track in the film ceases and stylus starts to tear the film or leave a ragged/sharp-edged grove as it first begins to climb over the film.

Through cure time: Through cure time is reached when the film has solidified so completely that the stylus on the drier no longer leaves any visible mark on the film.

Pot life: Pot life is defined as the time it takes to double the viscosity of polyamide/epoxy blend (60% solids) at 25° C.

1. A polyamide curative composition comprising a reaction product (P) of (1) at least three compounds of formula (I) H₂NCH₂CH₂(NHCH₂CH₂)ₓNH₂ with x=1 or higher with (2) a dimer fatty acid and (3) a carboxylic monoacid, with the proviso that the composition is free of tetrahydropyrimidine-containing compounds and free of piperazine-containing compounds and the proviso that the dimer fatty acid (2) building block of (P) contains less than 50% of non-cyclic dimer fatty acid isomers.

2. The polyamide curative composition according to claim 1, wherein compound (I) is a mixture comprising tetraethylenepentamine (TEPA), pentaethylenehexamine (PEHA) and hexaethyleneheptamine (HEHA).

3. The polyamide curative composition according to claim 1, wherein compound (I) is ethyleneamine E-100.

4. The polyamide curative composition according to claim 1, wherein the carboxylic monoacid (3) is tall oil fatty acid.

5. The polyamide curative composition according to claim 1, wherein compound (I) further comprises one or more polyamines (A), which are primary and/or secondary amines having at least two nitrogen atoms and at least two active amino hydrogen atoms per molecule with the proviso that the polyamines (A) are different from compounds of formula (I).

6. The polyamide curative composition according to claim 4, wherein the polyamine (A) is diethylenetriamine (DETA).

7. A method of making a polyamide curative composition, the method comprising:
mixing and heating (1) at least three compounds of formula (I) H₂NCH₂CH₂(NHCH₂CH₂)ₓNH₂ with x=1 or higher with (2) a dimer fatty acid and (3) a carboxylic monoacid, with the proviso that the composition is free of tetrahydropyrimidine-containing compounds and free of piperazine-containing compounds and the proviso that the dimer fatty acid (2) building block of (P) contains less than 50% of non-cyclic dimer fatty acid isomers;
forming a reaction product (P).

8. The method according to claim 7, wherein compound (I) is a mixture comprising tetraethylenepentamine (TEPA), pentaethylenehexamine (PEHA) and hexaethyleneheptamine (HEHA).

9. The method according to claim 7, wherein compound (I) is ethyleneamine E-100.

10. The method according to claim 1, wherein the carboxylic monoacid (3) is tall oil fatty acid.

11. A method of forming an epoxy, the method comprising: mixing the polyamide curative composition of claim 1 with an epoxy resin.
